(19) United States
(12) Patent Application Publication
(10) Pub. No.: US 2026/0057028 A1
(43) Pub. Date: Feb. 26, 2026

(54) GENERATIVE AI DATA ANALYSIS SYSTEM PROVIDING AN INTEGRATED USER INTERFACE AND THE METHOD THEREOF

(71) Applicant: NGeneBioAI, Inc, San Diego, CA (US)

(72) Inventors: Younggon KIM, San Diego, CA (US); Sangtae KIM, San Diego, CA (US)

(21) Appl. No.: 18/814,707

(22) Filed: Aug. 26, 2024

(51) Int. Cl. G06F 16/958; G06F 9/455; H04L 67/2895

(52) U.S. Cl. CPC G06F 16/958; G06F 9/45504; H04L 67/2895

(57) ABSTRACT

Provided is a generative AI data analysis system together with a method for providing an integrated user interface using a web server connected in a communication network with a client and an external LLM server, where the system relates to the generative AI data analyzing system and the method for providing the integrated user interface in which a web server outputs, on one web page, a prompt including a file path of a file to be analyzed input by the client, an analysis programming language generated by the external LIM server to correspond to the prompt, and execution result data of executing the analysis programming language on the file to be analyzed together.

### BACKGROUND

The present invention relates to a generative AI data analysis system and a method for providing an integrated user interface using a web server connected in a communication network with a client and an external LLM server, and more specifically, the present invention relates to the generative AI data analyzing system and the method for providing the integrated user interface in which a web server outputs, on one web page, a prompt including a file path of a file to be analyzed input by the client, an analysis programming language generated by the external LLM server to correspond to the prompt, and execution result data of executing the analysis programming language on the file to be analyzed together.

Data analysts suffer from various inconveniences in the process of analyzing data using generative AI. In an example, when using the programming language generated by the generative AI, the data analyst needs to copy the programming language outputted to the generative AI chatbot window and then put it in the data analysis program.

In particular, when the programming language generated by the generative AI is long, the data analyst may skip some programming language in the process of copying many rows, copy it, and then make a mistake of pasting it to the data analysis program. Due to such a mistake, an execution error occurs in the data analysis program, and poor execution result data is output.

Accordingly, the data analyst spends some time identifying the cause of the execution error or the cause of the output of the erroneous execution result data.

In addition, when the result data of the image type generated by the data analysis program needs to be analyzed again, the data analyst needs to perform an inconvenient task of capturing the result data and putting the result data into the generated AI. Moreover, when analyzing data by utilizing the generative AI, there is a problem in that a data analyst needs to display a plurality of working windows such as a generative AI chatbot window, a data analysis program window, and an image editing window on a computer screen, go back and forth, and analyze data.

### SUMMARY OF THE INVENTION

In order to solve the above problems, it is an object of the present invention to provide a generative AI data analysis system and a method thereof, in which a web server provides, on one web page, a prompt including a file path of a file to be analyzed input by a client, an analysis programming language generated by an external LLM server so as to correspond to the prompt, and an integrated user interface for outputting execution result data of executing the analysis programming language on the file to be analyzed together.

In addition, another object of the present invention is to provide a generative AI data analysis system and a method thereof, in which a user checks execution result data of a prompt including a file path on a web page, and then inputs a secondary prompt to obtain a secondary analysis result such as generation of a graph or a table using the initial execution result data to a client, and a web server outputs the secondary prompt, an analysis programming language generated by an external LLM server so as to correspond to the secondary prompt based on the initial execution results data, and the secondary execution result data obtained by executing the analysis programming language to the initial execution results.

A generative AI data analysis system for providing an integrated user interface of the present invention for accomplishing the object to be solved comprises a client and a web server connected to the client via a wired or wireless communication network,
the web server comprises a front-end processor that provides a web page that can receive a prompt from a client, and receives a first prompt including a file path of an analysis target file from the client on the web page; a back-end processor that receives a first prompt from the front-end processor, sends the first prompt to an external LLM server connected to a communication network, and receives a first analysis programming language generated by the external LLM server after requesting creation of the first analysis programming language corresponding to the first prompt; and a reverse proxy that receives the first analysis programming language transmitted by the back-end processor and transmits it to a tunnel client,
the client comprises a tunnel client coupled to the reverse proxy via a communication network and configured to receive the first analysis programming language from the reverse proxy; and a code execution processor that receives the first analysis programming language from the tunnel client, executes the first analysis programming language on the analysis target file, outputs the first execution result data, and transmits the first execution result data to the tunnel client,
the tunnel client transmits the first execution result data to the reverse proxy, and the reverse proxy transmits the first execution result data received from the tunnel client to the back-end processor, and the back-end processor transmits the first execution result data received from the reverse proxy and the first analysis programming language received from the external LLM server to the front-end processor, and the front-end processor outputs the first analysis programming language and the first execution result data received from the back-end processor to the web page where the first prompt is entered.

Furthermore, the front-end processor, when receiving a second prompt including a work instruction using the first execution result data from the client, transmits the second prompt to the back-end processor, the back-end processor transmits the first execution result data and the second prompt to an external LLM server, receives a second analysis programming language corresponding to the second prompt from the external LLM server, and transmits the second analysis programming language to the code execution processor through the reverse proxy and the tunnel server, the code execution processor executes the second analysis programming language on the first execution result data to output the second execution result data, and transmits the output second execution result data to the reverse proxy through the tunnel client, the back-end processor receives the second execution result data from the reverse proxy and transmits it to the front-end processor, and the front-end processor outputs the second analysis programming language and the second execution result data to the web page where the second prompt is entered.

The analysis target file, tunnel client and code execution processor are recorded in PC storage connected to the user terminal by wire, or recorded in on-premise storage to which the user terminal is connected via intranet, or recorded in cloud storage to which the user terminal is connected via a communication network.

The code execution processor comprises a Python kernel that interprets and executes the first and second analytical programming languages, and a kernel gateway that communicates with the tunnel client and creates and manages the Python kernel.

The Python kernel is preferably a Jupyter Notebook kernel, and the kernel gateway is a kernel gateway that creates and manages the Jupyter Notebook kernel, and the first and second analysis programming languages are preferably Python code or R code.

A generative AI data analysis method for providing an integrated user interface using a web server connected to a client via a wired or wireless communication network, the web server comprising a front-end processor, a back-end processor, a reverse proxy and a tunnel server, the method comprises, step (a) of receiving, by the front-end processor, a first prompt including a file path of an analysis target file from the client at a web page; step (b) of receiving, by the back-end processor, the first prompt from the front-end processor, requesting an external LLM server connected to the communication network to create a first analysis programming language corresponding to the first prompt, receiving the first analysis programming language generated by the external LLM server, and transmitting the received first analysis programming language to the front-end processor and the reverse proxy, respectively; step (c) of receiving, by the reverse proxy, the first analysis programming language from the back-end processor, transmitting the first analysis programming language to a tunnel client of a client connected to the communication network; step (d) of transmitting, by the tunnel client, the first analysis programming language received from the reverse proxy to the code execution processor of the client; step (e) of executing, by the code execution processor, the first analysis programming language received from a tunnel client on the analysis target file and transmitting the first execution result data outputted to the tunnel client; step (f) of transmitting, by the tunnel client, the first execution result data to the reverse proxy; step (g) of transmitting, by the reverse proxy, the first execution result data to the back-end processor; step (h) of transmitting, by the back-end processor, the first execution result data received from the reverse proxy to the front-end processor; and step (i) of receiving, by the front-end processor, the first execution result data from the back-end processor and outputting the first execution result data and the first analysis programming language received in the step (b) to a web page in which the first prompt is entered.

Furthermore, in the generative AI data analysis method providing an integrated user interface of the present invention, the front-end processor, when receiving a second prompt including a work instruction using the first execution result data from the client, transmits the second prompt to the back-end processor, the back-end processor transmits the first execution result data and the second prompt to an external LLM server, receives a second analysis programming language corresponding to the second prompt from the external LLM server, and transmits the second analysis programming language to the code execution processor through the reverse proxy and the tunnel server, the code execution processor executes the second analysis programming language on the first execution result data to output the second execution result data, and transmits the output second execution result data to the reverse proxy through the tunnel client, the back-end processor receives the second execution result data from the reverse proxy and transmits it to the front-end processor, and the front-end processor outputs the second analysis programming language and the second execution result data to the web page where the second prompt is entered.

As described above, according to the present invention, there is provided a generative AI data analysis system and a method thereof, in which a web server provides a prompt including a file path of a file to be analyzed entered by a client in one web page, an analysis programming language generated by an external LLM server so as to correspond to the prompt, and an integrated user interface for outputting execution result data of executing the analysis programming language on the file to be analyzed together.

In addition, according to the present invention, there is provided a generative AI data analysis system and a method thereof, wherein when a user checks execution result data of a prompt including a file path on a web page and inputs a secondary prompt to obtain a secondary analysis result, such as generating a graph or a table using the initial execution result data, to a client, a web server outputs the secondary prompt, an analysis programming language generated by an external LLM server so as to correspond to the secondary prompt based on initial execution result data and the secondary execution result data obtained by executing the analysis programming language to the initial execution results data, together on the one web page.

### BRIEF DESCRIPTION OF DRAWINGS

FIGS. 1 and 2 are diagrams illustrating components and relationships thereof that constitute a generative AI data analysis system that provides an integrated user interface according to an embodiment of the present invention.

FIGS. 3-9 are diagrams illustrating operational states of a generative AI data analysis system that provides an integrated user interface according to an embodiment of the present invention.

FIG. 10 is a flowchart of a generative AI data analysis method for providing an integrated user interface according to an embodiment of the present invention.

### DETAILED DESCRIPTION OF THE INVENTION

The present invention is made clear by referring to the embodiments described in detail in conjunction with the accompanying drawings. The present invention is not limited to the embodiments disclosed below. The invention is defined solely by the claims.

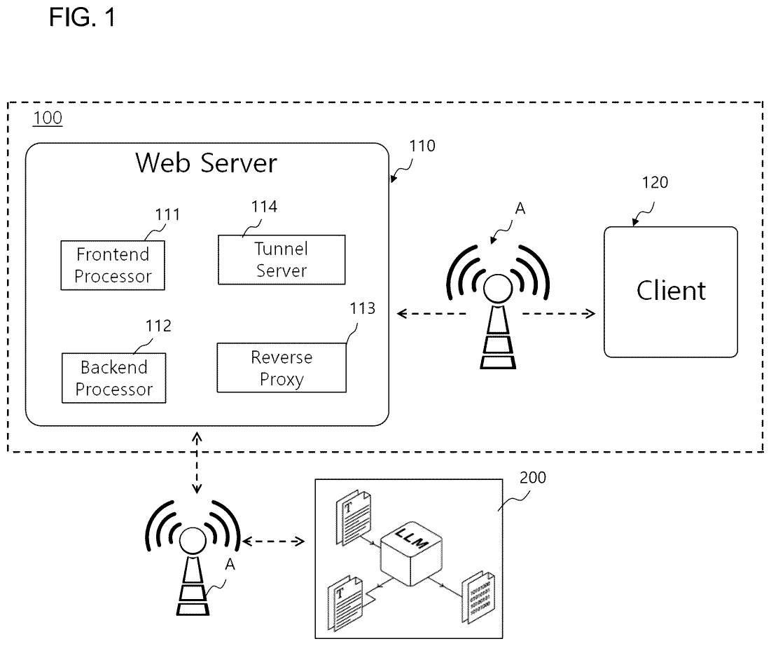

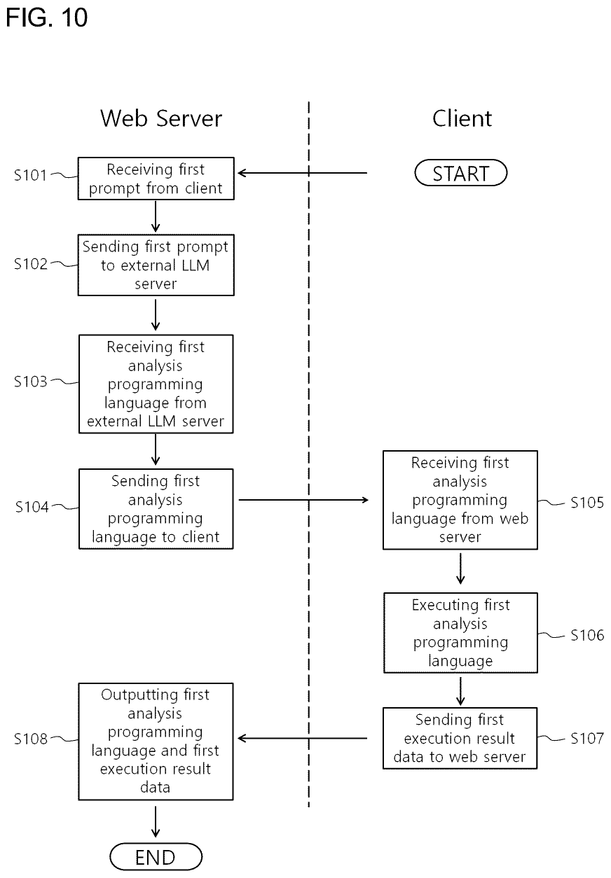

A generative AI data analysis system and a method thereof for providing an integrated user interface according to an embodiment of the present invention will be specifically described with reference to FIGS. 1 to 10.

A generative AI data analysis system 100 that provides an integrated user interface according to an embodiment of the present invention includes a client 120 and a web server 110 connected to a client 120 and an external LLM server 200 through a wired or wireless communication network A as shown in FIG. 1, and outputs a prompt input by the client 120, an analysis programming language generated by the external LLM server 200, and execution result data generated by the client 120 together on a web page. Here, the execution result data is data formed in a text format or an image format.

The web server 110 includes a front-end processor 111, a back-end processor 112, a reverse proxy 113, and a tunnel server 114 as shown in FIG. 1, and provides a web page 1111 to the client 120.

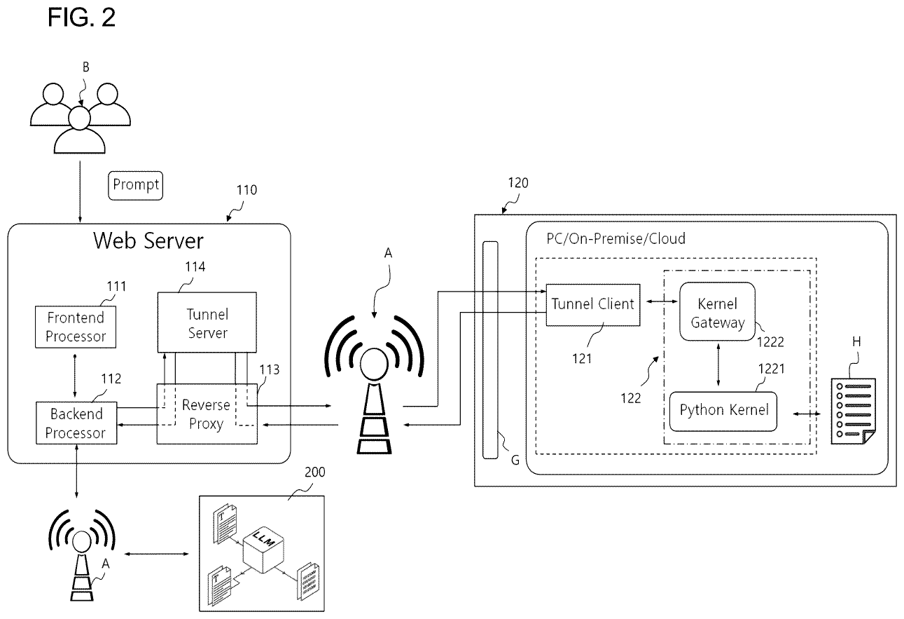

The client 120 is a computer-readable program recorded in a recording medium, and is recorded in a PC storage wiredly connected to a terminal of the user B, or is recorded in an on-premise storage to which the terminal of the user B is connected through an intranet, or is recorded on a cloud storage to which the user B's terminal is connected through a communication network A. Further, the client 120 includes a tunnel client 121 and a code execution processor 122 as shown in FIG. 2.

The analysis target file H including the data to be analyzed by the user is preferably stored together in a storage in which the client 120 is recorded. This is because the analysis target file (H) needs to be recorded together with the storage where the tunnel client (121) and code execution processor (122) of the client (120) are recorded to enable fast data processing.

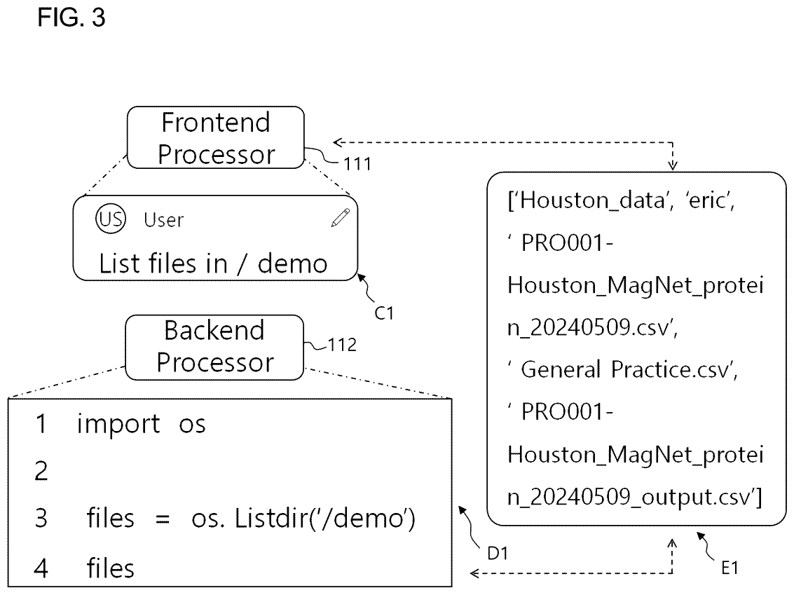

Hereinafter, with reference to FIGS. 3 to 10, an operation and a method of a generative AI data analysis system that provides an integrated user interface when the first prompt C1 to the n-th prompt Cn are input to the web page 1111 of the web server from the client 120 of the user B will be described.

The front-end processor 111 receives the first prompt C1 from the client 120 in the web page 1111 (step S101). In an example, the first prompt C1 as shown in FIG. 3 is input. The front-end processor 111 includes a user interface that provides a web page 1111 to which the first prompt C1 to the n-th prompt Cn are input from the client 120.

The back-end processor 112 receives the first prompt C1 from the front-end processor 111. Here, the first prompt C1 includes a file path of the analysis target file recorded in PC storage, on-premise storage, or cloud storage.

Then, the back-end processor 112 receives the first prompt C1 from the front-end processor 111, and transmits the first prompt C1 to the external LLM server 200, and requests the external LLM server 200 to create the first analysis programming language D1 corresponding to the first prompt C1 (step S102).

Then, the external LLM server 200 generates the first analysis programming language D1 corresponding to the first prompt C1, and then transmits the generated first analysis programming language to the back-end processor 112. The back-end processor 122 receives the first analysis programming languages D1 from the external LLM service 200 (step S103). In one example, the back-end processor 112 receives the first analysis programming language D1 as shown in FIG. 3 from the external LLM server 200.

Then, the back-end processor 112 transmits the first analysis programming language D1 received from the external LLM server 200 to the front-end processor 111 and the reverse proxy 113. The reverse proxy 113 receives the first analysis programming language D1 transmitted by the back-end processor 112, and transmits the first analysis programming languages D1 to the tunnel server 114 and the tunnel client 121 of the client 120 (step S104). Here, the reverse proxy 113 bypasses the firewall G and transmits the first analysis programming language D1 to the tunnel server 114.

The tunnel client 121 receives the first analysis programming language D1 from the reverse proxy 113 connected to a communication network A (step S105).

Then, the code execution processor 122 receives the first analysis programming language D1 from the tunnel client 121, and then executes the first analysis programming language D1 on the analysis target file to output the first execution result data E1 (step S106). In an example, the code execution processor 122 executes the first analysis programming language D1 as shown in FIG. 3, and outputs the first execution result data E1 as shown in FIG. 3.

Then, the code execution processor 122 transmits the first execution result data E1 to the tunnel client 121, and the tunnel client 121 transmits the first execution result data E1 to a reverse proxy 113 (step S107).

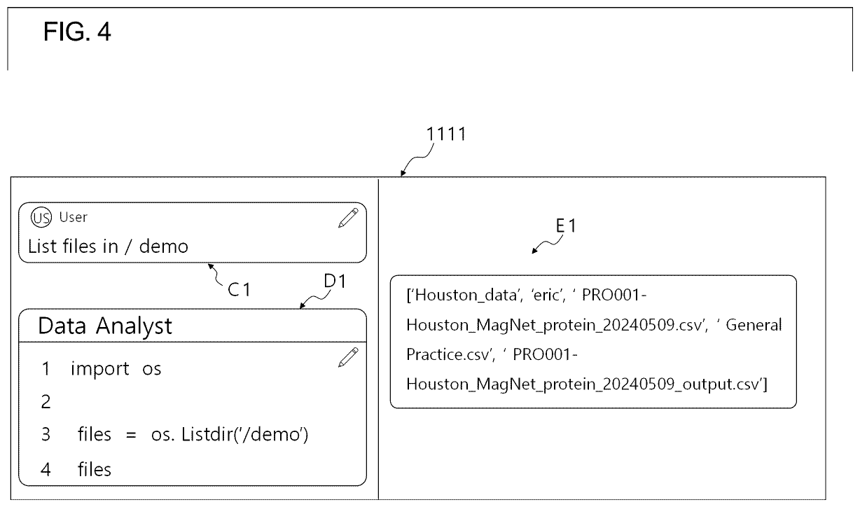

The reverse proxy 113 transmits the first execution result data E1 received from the client 120 to the tunnel server 114 and the back-end processor 112, and the back-ended processor 112 transmits the first execution result data E1 received by the reverse proxy 113 to the front-end processor 111. The front-end processor 111 receives the first execution result data E1 from the back-end processor 111, and outputs the first execution result information E1 and the first analysis programming language D1 received in step S104 to the web page 1111 to which the first prompt C1 is input as shown in FIG. 4 (step S108).

In this way, the generative AI data analysis system 100 that provides the integrated user interface of the present invention may output a prompt input from the client 120, an analysis programming language corresponding to the prompt, and execution result data corresponding to the analysis programming language to one web page.

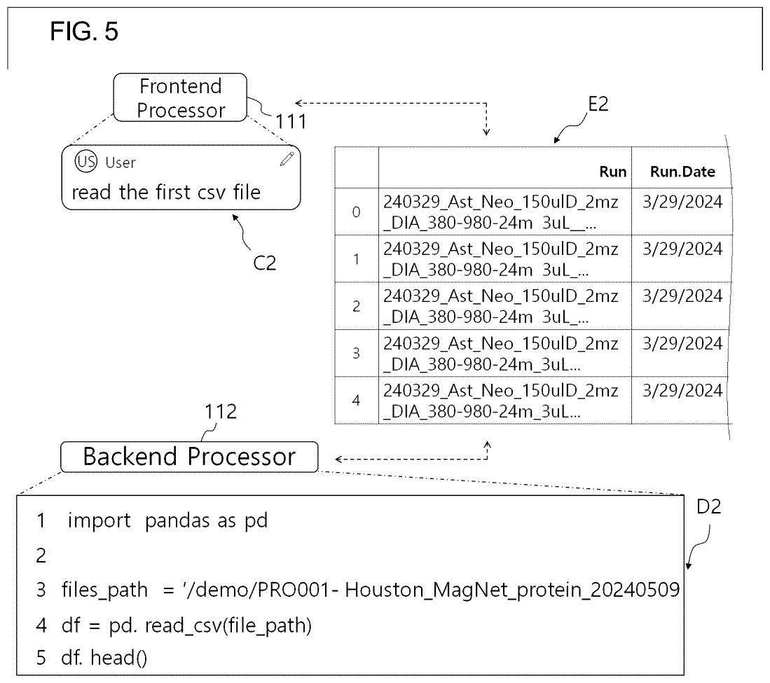

Hereinafter, an operation of the system according to the present invention when the second prompt C2 is input to the front-end processor 111 will be described with reference to FIG. 5.

The front-end processor 111 receives a second prompt C2 including an operation instruction using the first execution result data E1 from the client 120 as shown in FIG. 5. When the second prompt C2 is input, the front-end processor 111 transmits the first execution result data E1 and the second prompt C2, to the back-end processor 112. Then, the back-end processor 112 receives the first execution result data E1 and the second prompt C2 transmitted by the front-end processor 111. Then, the backend processor 112 transmits the first execution result data E1 and the second prompt C2 to the external LLM server 200 and requests the generation of the second analysis programming language D2 corresponding to the second prompt C2.

Then, the second analysis programming language D2 generated by the external LLM server 200 is received and transmitted to the reverse proxy 113. For example, the backend processor 112 receives the second analysis programming language D2 such as FIG. 5 from an external LLM server 200 and then transmits it to the reverse proxy 113.

The reverse proxy 113 transmits the second analysis programming language D2 to the client 120, and the client 120 executes the second analysis programming languages D2 on the first execution result data E1 that the code execution processor 122 had just output, generates second execution result data E2, and then transmits the second execution result data E2 to the web server 110.

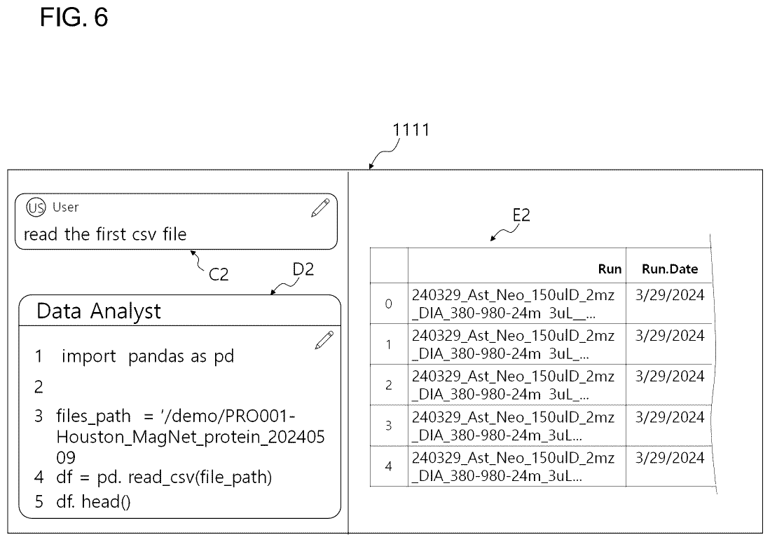

The web server 110 outputs the second execution result data E2 received from the client 120 to the web page 1111 to which the second prompt C2 is input, together with the second prompt C2, and the second analysis programming language D2 as shown in FIG. 6. Here, the front-end processor 111 arranges and outputs the second prompt C2, the second analysis programming language D2, and the second execution result data E2 at a preset position of the web page.

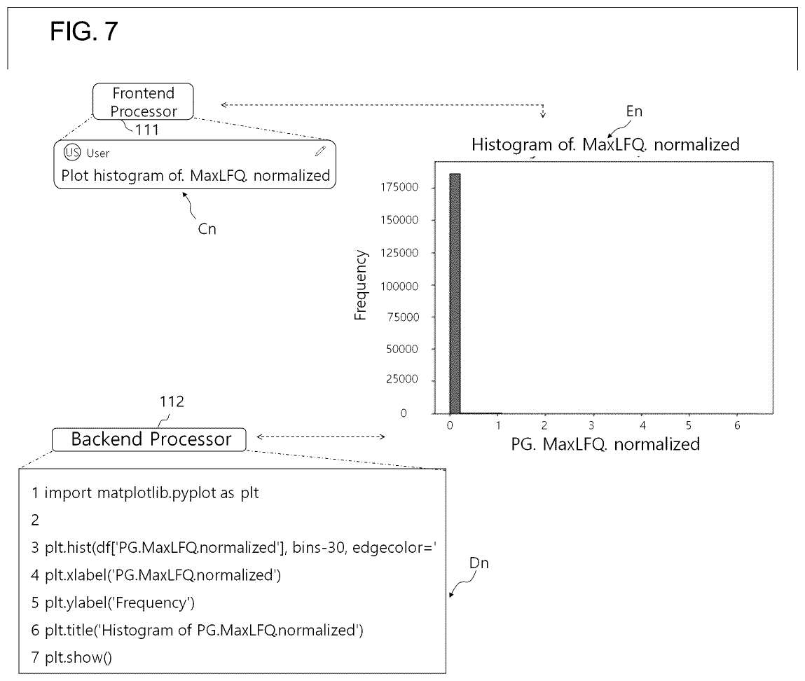

In addition, when an n-th prompt Cn including a work instruction using the second execution result data E2 generated by a client 120 is input to the front-end processor 111 of the web server, the present invention processes the n-th prompt Cn in the same manner as when the second prompt C2 is input to the front-end processor 111 of the web server, generates an n-th analysis programming language Dn corresponding to the n-th prompt Cn, and generates n-th execution result data En. For example, when the n-th prompt Cn as illustrated in FIG. 7 is input to the front-end processor 111 of the present invention, the external LLM server 200 generates an n-th analysis programming language Dn as illustrated in FIG. 7, and the client 120 outputs n-th execution result data En such as a table or graph as illustrated in FIG. 7.

In addition, as shown in FIG. 2, the code execution processor 122 of the present invention includes a Python Kernel 1221 that interprets and executes the first and second analysis programming languages and the n-th analysis programming language, and a kernel gateway 1222 that communicates with the tunnel client 121 and generates and manages the Python Kernel 1221. The Python Kernel 1221 is preferably a Jupyter Notebook kernel, and the kernel gateway 1222 is preferably a kernel gateway that generates and manages the Jupyter Note Book kernel. The above analysis programming language is preferably a Python code, but when the Python Kernel is a Jupyter Notebook kernel, the analysis programming language may be an R-code in addition to the Python code.

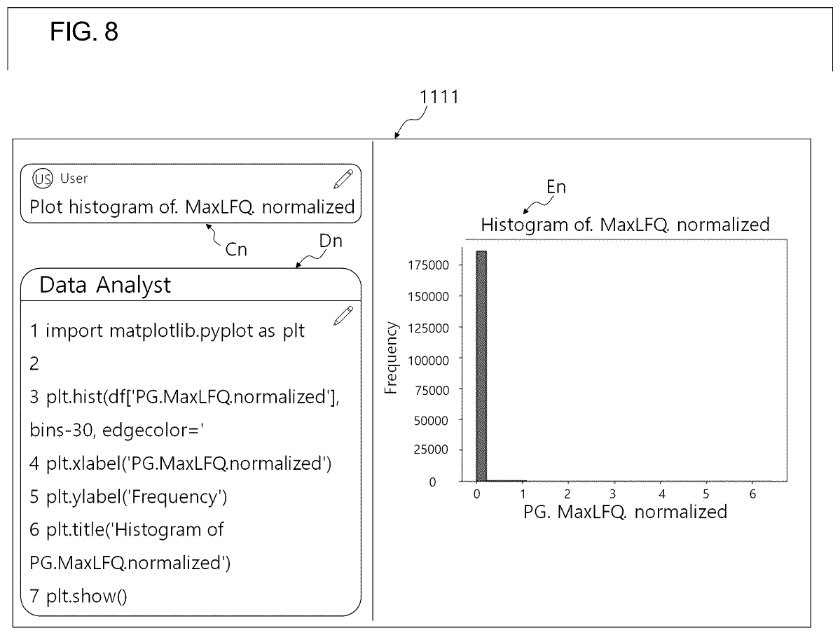

The code execution processor 122 independently executes each step using the Jupyter notebook kernel. For example, the present invention performs step 1 of loading a file as shown in FIG. 3, step 2 of preprocessing necessary columns as shown in FIG. 5, and the step 3 of generating execution result data using the plot library as illustrated in FIG. 7. In particular, when the present invention attempts to modify the execution result data output from step 3 (i.e., the execution result data of the image type), it does not execute the programming languages of steps 1 and 2, but executes only the programming language of step 3 that requires modification, using a client 120 using the Jupyter notebook kernel. FIG. 8 is a screen showing the execution result data En executed as above, together with the prompt Cn and the programming language Dn, printed on web page 1111. Therefore, the present invention can quickly process modification of execution result data.

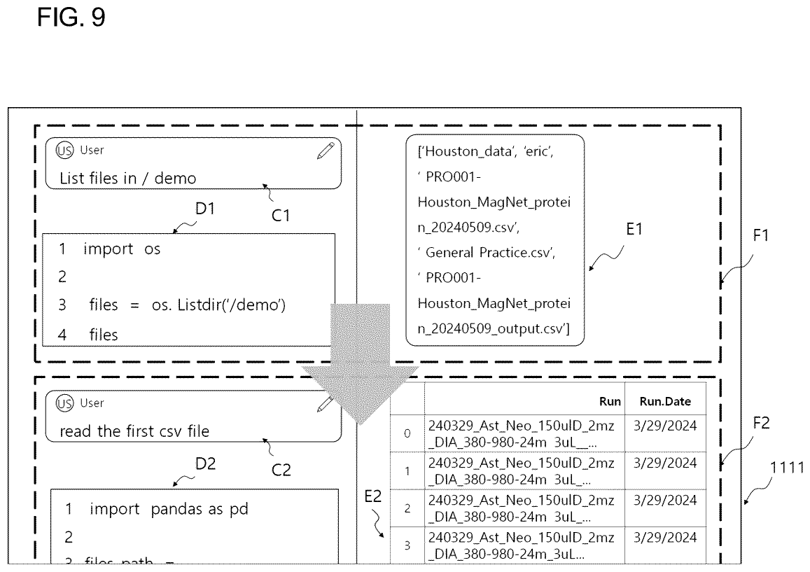

Hereinafter, a state in which a plurality of prompts, a plurality of analysis programming languages, and a plurality of analysis programming languages are continuously outputted to the web page 1111 will be described with reference to FIG. 9.

As shown in FIG. 9, the front-end processor 111 may set the first prompt C1, the first analysis programming language D1, and the first execution result data E1 arranged at a preset position to the first set data F1, and set the second prompt C2, the second analysis programming language D2, and the second execution result data E2 arranged at the preset position to the second set data F2. Then, the second set data F2 may be disposed on one web page in one lateral direction of the first set data F1. The client 120 outputs a part of the web page 1111 on the screen, and sends a scroll signal to the web page 11111 to move the screen of the web page in a downward direction, incrementally outputs second set data F2 on the web page, moves the screen in an upward direction, and incrementally outputs first set data F1 on the web page.

In this way, the generative AI data analysis system 100 providing the integrated user interface of the present invention sorts and outputs various set data in order of generation time, and enables the user to confirm the content of the analysis.

1. A generative AI data analysis system for providing an integrated user interface comprising a client and a web server connected to the client via a wired or wireless communication network,
wherein the web server comprises:
a front-end processor that provides a web page that can receive a prompt from a client, and receives a first prompt including a file path of an analysis target file from the client on the web page;
a back-end processor that receives a first prompt from the front-end processor, sends the first prompt to an external LLM server connected to a communication network, and receives a first analysis programming language generated by the external LLM server after requesting creation of the first analysis programming language corresponding to the first prompt; and
a reverse proxy that receives the first analysis programming language transmitted by the back-end processor and transmits it to a tunnel client;
wherein the client comprises:
a tunnel client coupled to the reverse proxy via a communication network and configured to receive the first analysis programming language from the reverse proxy; and
a code execution processor that receives the first analysis programming language from the tunnel client, executes the first analysis programming language on the analysis target file, outputs the first execution result data, and transmits the first execution result data to the tunnel client,
wherein the tunnel client transmits the first execution result data to the reverse proxy, and the reverse proxy transmits the first execution result data received from the tunnel client to the back-end processor, and the back-end processor transmits the first execution result data received from the reverse proxy and the first analysis programming language received from the external LLM server to the front-end processor, and the front-end processor outputs the first analysis programming language and the first execution result data received from the back-end processor to the web page where the first prompt is entered.

2. The system of claim 1, wherein the front-end processor, when receiving a second prompt including a work instruction using the first execution result data from the client, transmits the second prompt to the back-end processor,
the back-end processor transmits the first execution result data and the second prompt to an external LLM server, receives a second analysis programming language corresponding to the second prompt from the external LLM server, and transmits the second analysis programming language to the code execution processor through the reverse proxy and the tunnel server,
the code execution processor executes the second analysis programming language on the first execution result data to output the second execution result data, and transmits the output second execution result data to the reverse proxy through the tunnel client,
the back-end processor receives the second execution result data from the reverse proxy and transmits it to the front-end processor, and
the front-end processor outputs the second analysis programming language and the second execution result data to the web page where the second prompt is entered.

3. The system of claim 1, wherein the said analysis target file, tunnel client and code execution processor are recorded in PC storage connected to the user terminal by wire, or recorded in on-premise storage to which the user terminal is connected via intranet, or recorded in cloud storage to which the user terminal is connected via a communication network.

4. The system of claim 2, wherein the code execution processor comprises:
a Python kernel that interprets and executes the first and second analytical programming languages, and
a kernel gateway that communicates with the tunnel client and creates and manages the Python kernel.

5. The system of claim 4, wherein the Python kernel is a Jupyter Notebook kernel, and the kernel gateway is a kernel gateway that creates and manages the Jupyter Notebook kernel, and the first and second analysis programming languages are Python code or R code.

6. A generative AI data analysis method for providing an integrated user interface using a web server connected to a client via a wired or wireless communication network, the web server comprising a front-end processor, a back-end processor, a reverse proxy and a tunnel server, the method comprising:
step (a) of receiving, by the front-end processor, a first prompt including a file path of an analysis target file from the client at a web page;
step (b) of receiving, by the back-end processor, the first prompt from the front-end processor, requesting an external LLM server connected to the communication network to create a first analysis programming language corresponding to the first prompt, receiving the first analysis programming language generated by the external LLM server, and transmitting the received first analysis programming language to the front-end processor and the reverse proxy, respectively;
step (c) of receiving, by the reverse proxy, the first analysis programming language from the back-end processor, transmitting the first analysis programming language to a tunnel client of a client connected to the communication network;
step (d) of transmitting, by the tunnel client, the first analysis programming language received from the reverse proxy to the code execution processor of the client;
step (e) of executing, by the code execution processor, the first analysis programming language received from a tunnel client on the analysis target file and transmitting the first execution result data outputted to the tunnel client;
step (f) of transmitting, by the tunnel client, the first execution result data to the reverse proxy;
step (g) of transmitting, by the reverse proxy, the first execution result data to the back-end processor;
step (h) of transmitting, by the back-end processor, the first execution result data received from the reverse proxy to the front-end processor; and
step (i) of receiving, by the front-end processor, the first execution result data from the back-end processor and outputting the first execution result data and the first analysis programming language received in the step (b) to a web page in which the first prompt is entered.

7. The method of claim 6, wherein the front-end processor, when receiving a second prompt including a work instruction using the first execution result data from the client, transmits the second prompt to the back-end processor,
the back-end processor transmits the first execution result data and the second prompt to an external LLM server, receives a second analysis programming language corresponding to the second prompt from the external LLM server, and transmits the second analysis programming language to the code execution processor through the reverse proxy and the tunnel server,
the code execution processor executes the second analysis programming language on the first execution result data to output the second execution result data, and transmits the output second execution result data to the reverse proxy through the tunnel client,
the back-end processor receives the second execution result data from the reverse proxy and transmits it to the front-end processor, and
the front-end processor outputs the second analysis programming language and the second execution result data to the web page where the second prompt is entered.
